(19) United States
(12) Patent Application Publication
(10) Pub. No.: US 2019/0362446 A1
(43) Pub. Date: Nov. 28, 2019

(54) BLOCKCHAIN-BASED ENERGY TUNNELS FOR MULTI-TENANT DATA CENTERS

(71) Applicant: Eaton Intelligent Power Limited, Dublin 4 (IE)

(72) Inventor: George Arthur Navarro, Raleigh, NC (US)

(21) Appl. No.: 16/420,548

(22) Filed: May 23, 2019

Related U.S. Application Data
(60) Provisional application No. 62/676,556, filed on May 25, 2018.

(51) Int. Cl. G06Q 50/06; G06Q 10/06; G06Q 20/38

(52) U.S. Cl. CPC G06Q 50/06; G06Q 20/065; G06Q 20/381; G06Q 10/06315

(57) ABSTRACT

A system for managing energy provision in a multi-tenant data center (MTDC) includes respective tenant nodes corresponding to the respective tenants of the MTDC and a landlord node corresponding to the landlord. Respective service level agreement (SLA) smart contracts are established between respective ones of the tenant nodes and the landlord nodes, the smart contracts configured to allocate energy service levels to the tenant nodes based on blockchain-based service level token exchanges between the tenant nodes and the landlord node. The tenant nodes may be configured to exchange the service level tokens among themselves in exchange for a currency other than the service level tokens. The currency other than the service level tokens may include a fiat currency or a cryptocurrency.

### CROSS-REFERENCE TO RELATED APPLICATIONS

The present application claims the benefit of U.S. Provisional Patent Application No. 62/676,556; filed May 25, 2018.

### BACKGROUND

A significant number of organizations use multi-tenant data centers (MTDCs), sometimes referred to as co-location facilities, to meet their enterprise computing needs. Typical MTDCs provide space, power, HVAC, communications and security for customer-owned and maintained equipment. MTDCs can be advantageous in comparison to on-site data centers, as they can, for example, provide IT resources in a more efficient manner than on-site systems. MTDCs may also be able to expand to meet the organization's needs, as they are not necessarily constrained by the organization's home site limitations. MTDCs can also offer superior privacy and control in comparison to cloud-based solutions.

MTDCs can support customers with as little as a single server to the equivalent of a full-blown data center. Typically, MTDCs provide customers with floor space, power, network access and physical security at a monthly subscription rate. This infrastructure may be provided via service level agreement (SLAs) between the operator of the MTDC and the respective tenants that specify such things as a quantity of power to be delivered, a minimum availability limit for such power, and other figures of merit.

A potential disadvantage of such SLAs is that a given tenant often may not require the amount of power guaranteed in its SLA due to fluctuations in computational demand and other factors. Consequently, the tenant may end up paying too much for the power it receives under its SLA. Similarly, the tenant may also overpay for availability and reliability guarantees provided by its SLA. Conversely, if a given tenant requires additional power and/or other parameters that exceed SLA limits, the SLA may mandate surcharges for the use of the extra resources that may be undesirably high, even if the aggregate demand from the tenants of the facility does not exceed the sum of the limits in their SLAs.

### SUMMARY

Some embodiments of the inventive subject matter provide a system for managing energy provision in a multi-tenant data center (MTDC). The system includes respective tenant nodes corresponding to the respective tenants of the MTDC and a landlord node corresponding to the landlord. Respective service level agreement (SLA) smart contracts are established between respective ones of the tenant nodes and the landlord nodes, the smart contracts configured to allocate energy service levels to the tenant nodes based on blockchain-based service level token exchanges between the tenant nodes and the landlord node. The tenant nodes may be configured to exchange the service level tokens among themselves in exchange for a currency other than the service level tokens. The currency other than the service level tokens may include a fiat currency or a cryptocurrency.

Further embodiments provide methods of managing energy in a multi-tenant data center (MTDC). The methods include providing respective tenant nodes corresponding to respective tenants of the MTDC and providing a landlord node corresponding to the landlord. Service level agreement (SLA) smart contracts between respective ones of the tenant nodes and the landlord nodes. Energy service levels are allocated to the tenants based on blockchain-based service level token exchanges between the tenant nodes and the landlord node. The method may further include the tenant nodes exchanging the service level tokens among themselves in exchange for a currency other than the service level tokens.

Still further embodiments provide a non-transitory computer readable medium comprising computer program instructions that, when executed on a computing apparatus, establish a service level agreement (SLA) smart contract between a first tenant node associated with a first tenant of an MTDC and a landlord node associated with a landlord of the MTDC, the smart contract configured to provide energy service levels for the first tenant based on blockchain-based service level token exchanges between the first tenant and the landlord. The computer program instructions are further configured to transfer at least one service level token from the first tenant node to the landlord node to establish an energy service level for the first tenant node and to transfer at least one service level token from the first tenant node to a second tenant node in exchange for a currency other than the service level tokens.

### BRIEF DESCRIPTION OF THE DRAWINGS

FIG. 1 illustrates an energy blockchain tunnel architecture for a MTDC according to some embodiments.

FIG. 2 illustrates a blockchain-based token exchange arrangement for implanting the energy tunnel architecture of FIG. 1.

FIG. 3 illustrates a computer communication system that supports the token exchange arrangement of FIG. 2.

FIG. 4 is a graph illustrating potential energy demand reshaping using the system of FIGS. 1-3.

### DETAILED DESCRIPTION

The inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

In some embodiments MTDC tenants can exchange energy (capacity), power, and other energy-related service level quantities using blockchain-based smart contracts. As described herein, such smart energy contracts can, for example, enable the trading of capacity as defined by SLAs the tenants have with the landlord or other service provider for the MTDC. For example, a first tenant having excess capacity under an SLA can trade this capacity to a second tenant having insufficient capacity using a peer-to-peer (tenant-to-tenant) exchange of value, such as an exchange of service-level tokens for another currency, such as a fiat currency or bitcoin.

Capacity can be power capacity as in internal utility feeder capacity or energy storage capacity. Stored energy capacity could relate ancillary energy services like peak shaving to offset energy charges or energy capacity in support of backup time. The offering tenant's load can be low and so power capacity may be in excess and that capacity can be moved/allocated/offered to another tenant with an need for capacity due to insufficient capacity.

Ultimately, the use of such flexible capacity smart contracts can lead to better utilization of the MTDC energy infrastructure, as less capacity remains underutilized, untapped or stranded. Such contracts can also be used to negotiate better energy or demand capacity rates from the power utility companies.

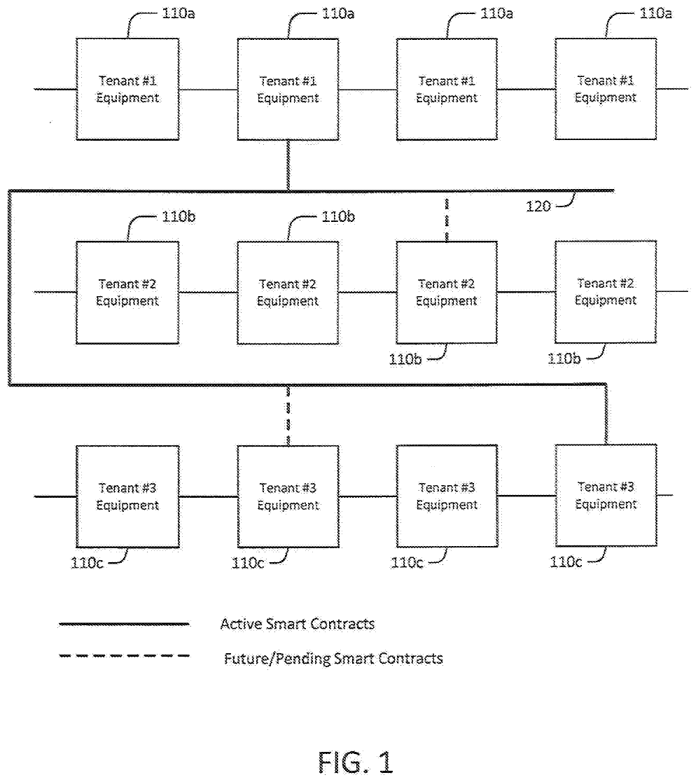

FIG. 1 illustrates a multi-tenant data center provided with blockchain-based “energy tunnels” (energy trading relationships) 120 wherein tenants having respective loads 110a, 110b, 110c may trade amongst themselves for power characteristics (e.g., amount and/or quality) collectively available to them under blockchain-based smart contract SLAs. This blockchain-based system may use a local or private cryptocurrencies that may be traded amongst the landlord and the tenants to allow them to, for example, avoid the inefficiencies associated with conventional static SLAs. The currency may be established by the tenants exchanging an amount of fiat or public cryptocurrencies (e.g., bitcoin or ether) for an amount of the private cryptocurrency to establish a monetary pool of the fiat and/or public cryptocurrency. The tenants may then trade energy credits using the private currency based on what they anticipate as their future requirements.

The tenant-to-tenant contract conditions and new SLA can be dynamically added/updated to the existing smart contract with the landlord; the landlord gets a cut of the payout, of course. This can be done with an open ledger or private ledger, depending on the level of trust between tenants and between tenants and landlord. Moreover, the new landlord or developer or business model can run/operate based on smart contracts at the outset and free and open smart contracts being a key component of the business model (between all of the tenants and/or the landlord).

Infrastructure capacity is transformed to an open source format, wherein tenants know each others energy use/capacity and can participate in tenant-to-tenant energy offers or bids. Smart contracts can be designed to balance the utility demand and improve grid utilization. While this may be disruptive to conventional arrangements used by utilities and other energy providers (including the MTDC owner), it can provide a more optimal and efficient use of energy resources. These blockchain based energy tunnels can cross-link previously independent and isolated power infrastructure and take advantage of power infrastructure adjacencies. This includes the communications network and power transfer (cross-link network). Embodiments may include control systems configured to control the energy contracts between tenants in an MTDC in transactions using a blockchain based currency.

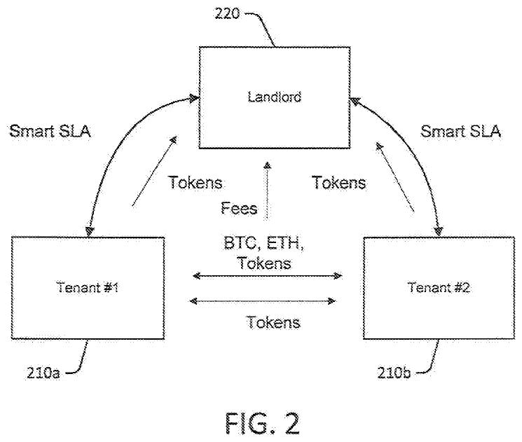

FIG. 2 illustrates an example of such a blockchain-based system. In the illustrated system, “smart” blockchain-based SLAs are used between a landlord node 220 and tenant nodes 210a, 210b. Under these smart SLAs, the tenant nodes 210a, 210b use digital tokens to “buy” a certain service level. The smart SLAs between the individual tenant nodes 210a, 1210 and the landlord node 220 could deliver service based on how many tokens the tenant node possesses, e.g., the more tokens paid, the higher level of service obtained. For example, the tenant nodes 210a could select from a menu of tiers of service corresponding to respective combinations of peak power consumption, total energy consumption, power quality, reliability, availability and the like.

In some embodiments, separate service level tokens could be used for different service components, e.g., peak power, power quality, etc. The tokens could be exchanged between the tenant nodes 210a using, for example, another digital currency (e.g., bitcoin or ether) or a fiat currency (e.g., using credit card payment channels) and/or, in the case of the use of multiple types of tokens, tokens of one type may be traded for tokens of another type. Such transactions could be validated for a public blockchain using a consensus mechanism or for a private blockchain using a recognized validator, such as the landlord node 220. The use of the distributed blockchain ledger can enable tenants to shop for capacity, as they can have access to records of previous token transactions. Thus, for example, a tenant finding itself with insufficient capacity under its existing SLA, could obtain additional tokens to obtain an increased service level from the landlord and/or another tenant, in a transparent market.

Such a system provides a dynamic SLA structure, with a total number of tokens available controlled by the landlord 220 to prevent over commitment of total resources. In some embodiments, the landlord node 220 could increase a total token availability to, for example, take advantage of capacity available under a general service agreement with the utility serving the MTDC and/or the availability of non-utility ancillary resources, such as locally generated power (e.g., solar or wind) or local energy storage or demand destruction. Conversely, the landlord node 220 could repurchase tokens from the tenant nodes 210a, 210b to accommodate decreases in available resources. This may be preferable, for example, to purchasing additional capacity from the utility at disadvantageous prices.

As can be understood from the illustrated example, blockchain-based energy tunnels are not physical infrastructure (e.g., electrical distribution wiring) that distributes power, but rather communications systems that implement financial relationships that can be used to constrain use of available resources and infrastructure. An exchange between tenant nodes can produce a change in energy demanded by each of the tenants through behavioral effects, which can virtually “re-wire” the MTDC. Advantages of such a system can include, but are not limited to, deferral of costs that may be associated with changes in physical infrastructure. Such a system can also reduce transactional costs of negotiating new SLAs to accommodate changes in tenant demand.

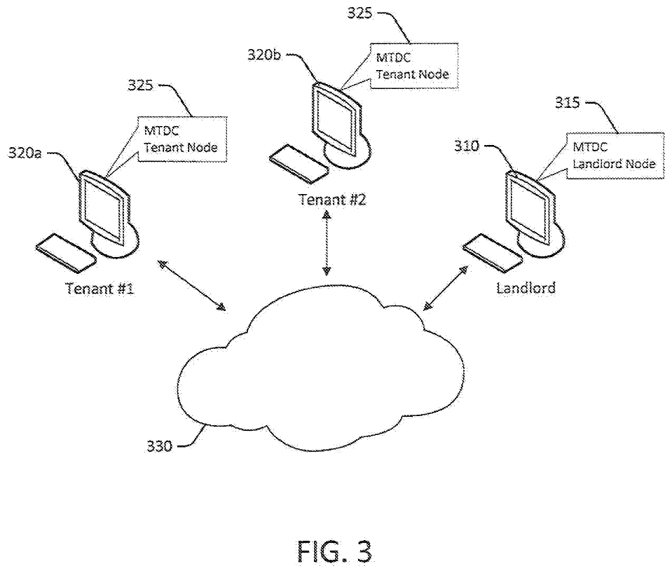

An example implementation of such a communications system is illustrated in FIG. 3, which shows tenant computers 320a, 320b that implement MTDC tenant nodes 325 along the lines discussed above with reference to FIG. 2. A landlord computer 310 implements an MTDC landlord node 315 along the lines illustrated in FIG. 2. In the illustrated applications, the computers 310, 320a, 320b communicate via a network 330, e.g., an internet. It will be appreciated, however, that although FIG. 3 illustrates respective nodes on separate respective computers, the nodes could also be implemented in shared hardware and/or some of the nodes may be distributed across multiple hardware platforms. It will be further appreciated that the hardware hosting the MTDC landlord and tenant nodes 315, 325 may be located at the MTDC and/or at a remote location.

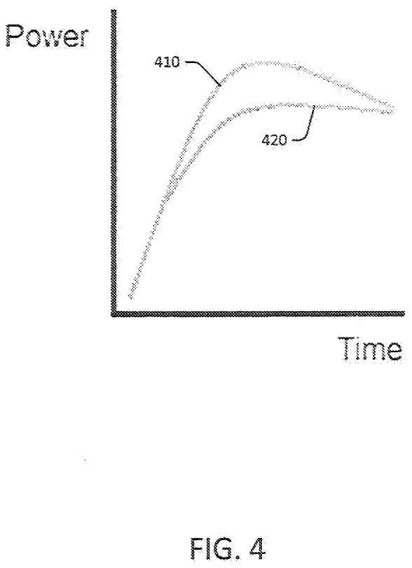

The virtual exchange of tokens can also produce desirable effects on energy demanded from the utility grid by the MTDC. As illustrated in FIG. 4, coordinated exchange of tokens can be used to flatten the MTDC load curve 420 during expensive peak periods (demand response and peak shaving), in comparison to a load curve 410 without such token exchange. In particular, tenants may respond more effectively to market signals and tailor their computing operations to better optimize energy consumption. This can provide payback to the landlord, thus providing further incentive for the landlord to support such a system.

According to further aspects, tokens could also be redeemed (e.g., at the end of a month or year) to pay rent or other obligations. Owner and tenants effectively participate in energy markets by operating as a collective driven not by technically intensive and expensive equipment, but a financial/virtual exchange of value. According to still further aspects, smart contracts between tenants can also establish future commitments (and over time periods) to address energy critical days of the weeks and months/season of the year. Many, if not all, of these measures may be implemented without tenant interaction with the utility.

Example embodiments are described above with reference to block diagrams and/or flowchart illustrations of methods, devices, systems and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a tangible or non-transitory computer-readable storage medium that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, example embodiments may be implemented in hardware and/or in software (including firmware, resident software, micro-code, etc.). Furthermore, example embodiments may take the form of a computer program product on a computer-usable or computer-readable storage medium having tangible, non-transitory computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CO-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A system for managing energy in a multi-tenant data center (MTDC), the system comprising:
respective tenant nodes corresponding to the respective tenants of the MTDC;
a landlord node corresponding to the landlord; and
respective service level agreement (SLA) smart contracts between respective ones of the tenant nodes and the landlord nodes, the smart contracts configured to allocate energy service levels to the tenant nodes based on blockchain-based service level token exchanges between the tenant nodes and the landlord node.

2. The system of claim 1, wherein the tenant nodes are configured to exchange service level tokens among themselves in exchange for a currency other than the service level tokens.

3. The system of claim 2, wherein the currency other than the service level tokens comprises a fiat currency or a cryptocurrency.

4. The system of claim 2, wherein the landlord node controls a total number of service level tokens issued to the tenants and wherein the tenant nodes are configured to redistribute the issued service level tokens among themselves responsive to exchanges using the currency other than the service level tokens.

5. The system of claim 4, wherein the landlord node is configured to increase an available number of the service level tokens in responsive to an increase in power or energy capacity available to the MTDC to thereby increase power or energy available to the tenants.

6. The system of claim 4, wherein the landlord node is configured to decrease an available number of the service level tokens responsive to a decrease in power or energy capacity available to the MTDC to thereby decrease power or energy available to the tenants.

7. The system of claim 1, wherein the service level token exchanges invoke respective different types of service level tokens for respective different service level parameters.

8. A method of managing energy in a multi-tenant data center (MTDC), the method comprising:
providing respective tenant nodes corresponding to respective tenants of the MTDC;
providing a landlord node corresponding to the landlord;
establishing service level agreement (SLA) smart contracts between respective ones of the tenant nodes and the landlord nodes; and
allocating energy service levels to the tenants based on blockchain-based service level token exchanges between the tenant nodes and the landlord node.

9. The method of claim 8, further comprising the tenant nodes exchanging the service level tokens among themselves in exchange for a currency other than the service level tokens.

10. The method of claim 9, wherein the currency other than the service level tokens comprises a fiat currency or a cryptocurrency.

11. The method of claim 9, further comprising:
the landlord node controlling a total number of the service level tokens issued to the tenants; and
the tenant nodes redistributing the issued service level tokens among themselves responsive to exchanges using the currency other than the service level tokens.

12. The method of claim 11, wherein the landlord node controlling a total number of service level tokens issued to the tenants comprises the landlord node increasing an available number of the service level tokens in responsive to an increase in power or energy capacity available to the MTDC to thereby increase power or energy available to the tenants.

13. The method of claim 11, wherein the landlord node controlling a total number of the service level tokens issued to the tenants comprises the landlord node decreasing an available number of the service level tokens responsive to a decrease in power or energy capacity available to the MTDC to thereby decrease power or energy available to the tenants.

14. The method of claim 8, wherein the service level token exchanges involve respective different types of service level tokens for respective different service level parameters.

15. A non-transitory computer readable medium comprising computer program instructions that, when executed on a computing apparatus, perform the following operations:
establishing a service level agreement (SLA) smart contract between a first tenant node associated with a first tenant of an MTDC and a landlord node associated with a landlord of the MTDC, the smart contract configured to provide energy service levels for the first tenant based on blockchain-based service level token exchanges between the first tenant and the landlord;
transferring at least one service level token from the first tenant node to the landlord node to establish an energy service level for the first tenant node; and
transferring at least one service level token from the first tenant node to a second tenant node in exchange for a currency other than the service level tokens.

16. The computer readable medium of claim 15, wherein the currency other than the service level tokens comprises a fiat currency or a cryptocurrency.
